(19) United States
(12) Patent Application Publication
(10) Pub. No.: US 2005/0260953 A1
(43) Pub. Date: Nov. 24, 2005

(54) Wireless aviation headset

(76) Inventors: Brad Lefler, Prineville, OR (US); Timothy Jay Wilson, Prineville, OR (US); David G. Callon, Prineville, OR (US)

Correspondence Address: National IP Rights Center, LLC, Suite 400, 550 Township Line Road, Blue Bell, PA, 19422, US

(21) Appl. No.: 10/848,554

(22) Filed: May 18, 2004

(51) Int. Cl. H04B 1/034

(52) U.S. Cl. 455/100

(57) ABSTRACT

A wireless communication system for use in an aircraft comprising: a battery powered wireless head set with ear cups and a boom microphone and having a transmitter and receiver to transmit and receive communications inside and outside the aircraft; and a control box housing a transmitter and receiver attached to the communication system of the aircraft to permit the wireless head set to connect with the aircraft communication system.

### FIELD OF THE INVENTION

The present invention is directed to a wireless headset for use in aviation to allow greater convenience in the cockpit and greater flexibility of pilot movement.

### BACKGROUND OF THE INVENTION

The present invention is directed to a novel wireless aviation headset. The headset has an aircraft module transmitter/receiver portion that would plug into the headphones and microphone jacks in the aircraft and a headset portion that would transmit and receive a communications signal from the aircraft module. The wireless headset would allow greater convenience in the cockpit and greater flexibility of movement.

Aviation headgear is used by professional and private pilots throughout the world. The purposes of this headset is to enable the pilot to communicate with the ground and with the co-pilot unimpeded by background. Most general aviation aircraft were originally built with a hand held microphone and a speaker mounted in the cabin. Over the last thirty years headsets with speakers built into the ear cups and boom mounted microphones have become the norm. The headset reduces ambient noise, improving and protecting hearing. The headset also allows for hands free communication by way of the boom microphone. The current state headset connects to the aircraft communication system with a cord and jack assembly.

While the current headset is a market improvement over the prior system, the cord from the headset to the aircraft can restrict head and arm movement.

There are a large number of patents which have issued on various wireless transmitters and headsets. U.S. Pat. No. 5,982,904 discloses a wireless headset comprising: a microphone for receiving a first audio signal and for generating a corresponding microphone electrical signal; a portable receiver/transmitter electrically connected to the microphone for transmitting a first carrier frequency modulated according to the microphone's electrical signal; a remote receiver/transmitter for receiving and demodulating the modulated first carrier frequency to generate a first electrical signal corresponding to the microphone electrical signal, the remote receiver/transmitter also for transmitting a second carrier frequency modulated according to a second electrical signal; the portable receiver/transmitter also for receiving and demodulating the second modulated carrier frequency to generate a speaker electrical signal; and a speaker electrically connected to the portable receiver/transmitter for transforming the speaker's electrical signal into a second audio signal, one of the first and second carrier frequencies being above 900 Megahertz, the other of the first and second carrier frequencies being below 900 Megahertz.

U.S. Pat. No. 5,095,382 discloses a wireless headphone in which an infra-red light signal transmitted from a transmitting apparatus is received and reproduced as an audible sound by a headphone unit portion. A first light receiving element is provided on a top portion of a head band portion of the headphone so that, when a listener wears the wireless headphone, a light receiving surface included in the first light receiving element is directed rearward. Second and third light receiving elements are provided on the pair of headphone unit portions so that, when the listener wears the wireless headphone light receiving surfaces included in the second and third light receiving elements are directed forward.

U.S. Pat. No. 5,357,585 discloses a headphone assembly adapted for engaging a user's head includes an adjustable headband having first and second ends. A right ear piece is attached to a first end, and a left ear piece is attached to a second end of the headband. Each ear piece is substantially semi-circular shaped, and has a substantially inverted U-shaped shell having an inverted U-shaped inner wall. The U-shaped inner wall defines an acoustic cavity having a bottom end opening for receiving approximately the top half of the user's ear. A rear wall of the acoustic cavity has a number of holes extending therethrough behind which a speaker is mounted. An inverted U-shaped chamber is provided about the acoustic cavity and the outer perimeter of the ear piece. The right ear piece chamber will hold the electronic circuitry necessary for a cordless receiver. The left ear piece has a similar chamber which accepts a power board for holding a plurality of batteries which provides the power source for the electronic circuitry mounted in the opposite ear piece. A dome-shaped cover plate covers each of the speaker elements and the respective power board and circuit board, to create a cordless headphone wherein the user's ear is only partially enclosed by the ear piece. Foam pads mounted on the ear pieces contact the user's head to provide comfort to the user.

U.S. Pat. No. 6,246,772 discloses a wireless headphone/speakers sound field control system, which includes a wireless signal receiver, a left speaker connected to the wireless signal receiver through a left differential amplifier and a left variable resistor, and a right speaker connected to the wireless signal receiver through a right differential amplifier and a right variable resistor, each of the left and right variable resistors being respectively connected to the positive pole of each of the left and right differential amplifiers, wherein a phase-shifting circuit is connected between the left differential amplifier and the right differential amplifier, having two sub-circuits each formed of a first capacitor, a variable resistor, a second capacitor and a resistor, each sub-circuit being connected in series between the right or left variable resistor and the left or right differential amplifier, the phase-shifting circuit enabling the differential amplifiers to have a dual signal input, so that left sound channel signal is inputted into the right differential amplifier and right sound channel signal is inputted into the left differential amplifier to achieve a stereo effect.

U.S. Pat. No. 4,815,143 discloses a wireless microphone having an on/off safety switch, and a mute safety switch. The microphone includes a generally elongated handle, having a slit-like elongated slot, disposed on the side of the microphone, for substantially entirely housing an on/off control button and detent, and a mute control button and locking detent, out of contact with the user's fingers, in order to prevent inadvertent manipulation thereof.

U.S. Pat. No. 5,621,913 discloses a system for wireless communication between a plurality of semiconductor chips. Each data line in the present invention is coupled with a transmitter for transmitting information to any other semiconductor chip. Furthermore, each data line is coupled with a receiver for receiving information transmitted by any transmitter. The system also comprises multiple antennas, fabricated from the chip's metalization layer. Nonetheless, separate antennas within the chip packaging can also be used. The antenna unit comprises a dipole and a loop antenna in a planar arrangement, thereby forming a spherical electromagnetic pattern of coverage and making the orientation between semiconductor chips for transmission purposes substantially irrelevant. Each transmitter in the system comprises a modulator for modulating the information being transmitted, while each receiver comprises a demodulator for demodulating the information transmitted. Several modulation schemes can be employed, though amplitude modulation is preferred, whereby each transmitter has a distinct carrier frequency within the operative radio frequency spectra—preferably above 900 MHz. Each transmitter and receiver is coupled to a power source comprising a capacitor, as a signal generator, and a rectifying circuit. To ensure that the communication between chips is noise/interference free, the entire system is shielded with a metal housing.

U.S. patent application Ser. No. 2003/0013498 discloses a wireless earphone, which mainly comprises a main part of the wireless earphone, a sunken part, a hole which are set on the top of the main part, several slots and position holes which are set around the sunken part to make the upper cover be positioned and joined. Therefore, the upper cover is easy to be assembled and disassembled. In addition, a base is extended form the bottom of the main part and further has a rotating part, which can rotate, inside. A channel is set on the rotating part to let the ear-hanger be inserted into the channel and be able to rotate in the channel such that the ear-hanger can be hanged at the left/right ear of the user and can be adjusted properly due to thickness of the user's ear style. The hole of the top of the main part can be joined with a position set. A joining hole is set on the position set to be joined with a head-ring and make the head-ring rotate in the joined hole such that the head-ring also can be adjusted to make the user can choose a wireless earphone of ear-hang type or headphone type

While there have been a wide assortment of wireless headset systems, none have been directed to cockpit use. The elimination of the cord in aviation (fixed wing and rotor) would allow the aircraft operator a greater range of movement, eliminate the problem of tangled cords with arms and legs and aircraft controls, and can reduce neck strain from the weight of the cord pulling down on one side. The ear-headset seal would be further enhanced with the elimination of the cord snagging on arms, clothing, and other items and pulling the headset out of position on the user's head.

It is therefore a principal object of the invention to make the headset cordless and self-contained.

It is a further object of the invention to keep the noise reducing properties and hands free capabilities of the headset.

It is still a further object of the present invention to provide a an aviation head by replacing the cord connection with a low power transmitter and receiver built into one of the ear-cups.

It is a further object of the invention to provide a separate module incorporating a receiver and transmitter which connects to the existing aircraft communication system.

These and other objects of the present invention will become apparent from the detailed description which follows.

### SUMMARY OF THE INVENTION

In accordance with the present invention, a wireless communication system for use in an aircraft is disclosed. The invention comprises a wireless head set with ear-cups and a microphone and having a transmitter and receiver to transmit and receive communications inside and outside the aircraft; a transmitter and receiver box attached to the communication system of the aircraft to permit the wireless head set to connect with the aircraft communication system.

In a further embodiment, the invention comprises a wireless communication system for use in an aircraft comprising: a battery powered wireless head set with earcups and a boom microphone and having a transmitter and receiver to transmit and receive communications inside and outside the aircraft; and a control box housing a transmitter and receiver attached to the communication system of the aircraft to permit the wireless head set to connect with the aircraft communication system.

In yet a further embodiment, the invention is a wireless communication system for use in an aircraft comprising: a battery powered wireless head set with ear cups and a boom microphone and having a transmitter and receiver to transmit and receive communications inside and outside the aircraft; a control box housing a transmitter and receiver attached to the communication system of the aircraft to permit the wireless head set to connect with the aircraft communication system; and a frequency control system to adjust the frequency of the communication system.

### BRIEF DESCRIPTION OF THE FIGURES

FIG. 1 is a perspective view of the ear-set of the present invention.

FIG. 2 is the wireless transmitter box of the present invention.

FIG. 3 is a view of the overall system.

### DETAILED DESCRIPTION OF THE INVENTION

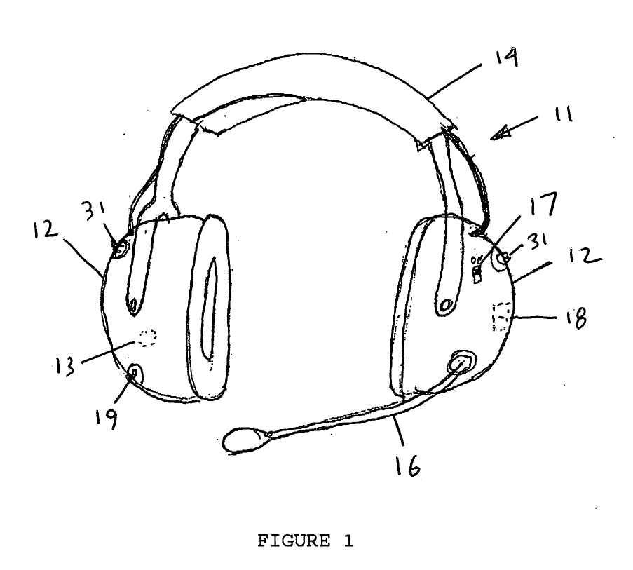

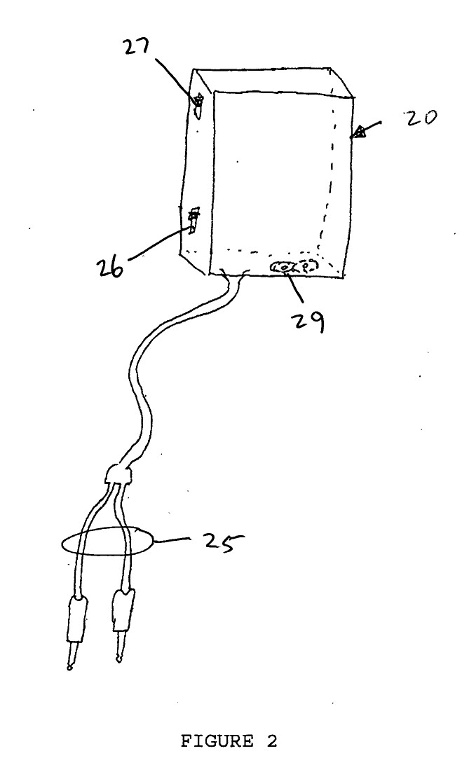

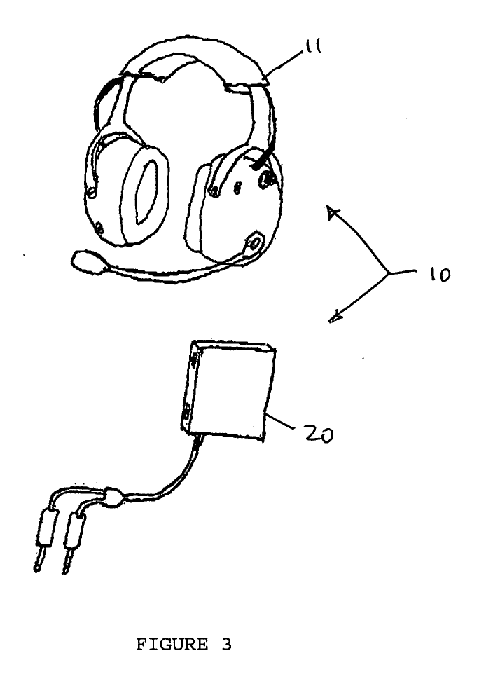

The present invention is now described with reference to the enclosed Figures. Referring to FIG. 3, the invention is broadly shown as a headset with wireless communication system 10. Referring now to FIGS. 1 and 2, the headset comprises a standard headset 11 with two cupped earphones 12, u-shaped head mount 14 and boom microphone 16 which is connected by wire to a transmitter/receiver 18. An on/off switch 17 is included on the headset 11 to turn the unit on and off. Volume controls 31 are mounted on each ear cup 12 which allow the wearer to adjust the volume.

A rechargeable battery system 13 is incorporated into one of the ear-cups 12. The battery 13 should be a lithium battery and similar to that of a cellular phone battery and be capable of providing power up to twelve hours. However, any type of battery known to one of ordinary skill in the art may be utilized.

The wireless transmitter/receiver 18 is situated within one of the ear sets 12 and includes a small antenna (not shown).

A second transmitter/receiver 20 is connected by the aviation jacks 25 to the communication systems of the aircraft. An on/off switch 27 is included on the transmitter/receiver 20 to turn the unit on and off.

The wireless boom microphone 16 transmits via the transmitter/receiver 20 connected to the aircraft on a discrete frequency. The transmitter/receiver systems 18 and 20, because it is only used within the aircraft should be set at a frequency so as to avoid interference with other air or ground traffic, cellular phones, wireless modems and the like. Because the system is to be used within a cockpit, it is not essential that the wireless transmitter/receivers 18 and 20 be high power. Because of the close proximity, the system can be set up to work on an amp of current or less. In a preferred embodiment of the present invention, the transmitter/receiver 20 is in the form of a control box.

Communication from the aircraft system is sent from the aircraft communications module via an automatic activating transmitter to the headset on a separate frequency and received by the headset receiver 18 tuned to the same frequency. This combination allows for simultaneous transmission and reception of the headset, providing for a nearly seamless communication circuit without the cord. The rechargeable battery in the headset and the aircraft module are recharged via a power port 19 on the headset and power port 29 on the transmitter/receiver 20.

The power ports 19 and 20 can also be utilized for back up power in the event of battery failure during use. The system should also include an “A/B” frequency selector incorporated in both the headset and transmitter/receiver to isolate the headset and transmitter/receiver 20 from close interference or to improve system flexibility. The transmitter/receiver 20 includes A/B switch 26.

These and other objects of the invention will become apparent from the detailed claims which follow.

1. A wireless communication system for use in an aircraft comprising:
a wireless head set with ear cups and a microphone and having a transmitter and receiver to transmit and receive communications inside and outside the aircraft; and
a transmitter and receiver box attached to the communication system of the aircraft to permit the wireless head set to connect with the aircraft communication system.

2. The wireless communication system of claim 1 further comprising a battery pack connected with the head set to power the transmitter and receiver within the headset.

3. A wireless communication system for use in an aircraft comprising:
a battery powered wireless head set with ear-cups and a boom microphone and having a transmitter and receiver to transmit and receive communications inside and outside the aircraft; and
a control box housing a transmitter and receiver attached to the communication system of the aircraft to permit the wireless head set to connect with the aircraft communication system.

4. A wireless communication system for use in an aircraft comprising:
a battery powered wireless head set with ear cups and a boom microphone and having a transmitter and receiver to transmit and receive communications inside and outside the aircraft; and
a control box housing a transmitter and receiver attached to the communication system of the aircraft to permit the wireless head set to connect with the aircraft communication system; and
a frequency control system to adjust the frequency of the communication system.
